(19) United States
(12) Patent Application Publication
(10) Pub. No.: US 2013/0271506 A1
(43) Pub. Date: Oct. 17, 2013

(54) BACKLIGHT CONTROL METHOD AND BACKLIGHT SYSTEM

(71) Applicant: WISTRON CORPORATION, New Taipei City (TW)

(72) Inventors: Tsang-Hsing Lee, New Taipei City (TW); Pei-Chi Tsai, New Taipei City (TW)

(73) Assignee: WISTRON CORPORATION, New Taipei City (TW)

(21) Appl. No.: 13/712,983

(22) Filed: Dec. 13, 2012

(30) Foreign Application Priority Data
Apr. 13, 2012 (TW) 101113222

(51) Int. Cl. G09G 5/10

(52) U.S. Cl. CPC G09G 5/10
USPC 345/690

(57) ABSTRACT

A backlight control method for a backlight module corresponding to a display panel is disclosed, which includes the steps of dividing the backlight module into a plurality of backlight areas, calculating a first blanking period, a active pixel period and a second blanking period of an image frame, sequentially turning on light sources of the plurality of backlight areas to provide backlights for the display panel during the active pixel period, wherein light sources of each backlight area is turned on and lasted to a light-on duration, the active pixel period begins at a time point of displaying the first active pixel of the image frame and ends at a time point of displaying the last active pixel of the image frame.

### BACKGROUND OF THE INVENTION

1. Field of the Invention

The present invention relates to a backlight control method and a backlight system thereof, and more particularly, to a backlight control method and related backlight system capable of reducing power consumption and improving flickering effect.

2. Description of the Prior Art

Light emitting diodes (LEDs) offer advantages of energy savings, long device lifetime, no mercury used, high achievable color gamut, without idle time, and fast response speed, so that LED technology is widely applied in fields of light sources for display and illumination. For example, a conventional liquid crystal display (LCD) usually uses cold cathode fluorescent lamps (CCFLs) as a light source of a backlight module to illuminate a display panel. However, as the luminous efficiency increases and the cost decreases, LEDs have gradually replaced CCFLs to be the light source in the back light module.

Please refer to FIG. 1, which is a schematic diagram of an LCD system 10 using LED backlighting according to the prior art. As shown in FIG. 1, a host 102 receives an image signal S and transmits the image signal S to a panel driving chip 106. Accordingly, the panel driving chip 106 controls image output of a display panel 110 for a display device 108. A backlight module 112 of the display device 108 uses LEDs as light sources to provide backlights for the display panel 110, so as to achieve image display purpose. Furthermore, the host 102 includes an image scaler 104. The image scaler 104 is utilized for scaling the image signal S to generate relative resolution information and a corresponding image signal for the panel driving chip 106 and a backlight control chip 114 according to an expected display output standard with specific resolutions and aspect ratios. The backlight control chip 114 drives the backlight module 112 to provide the backlights for the display panel 110 according to the information from the image scaler 104.

In general, a conventional full-on/full-off control method or scanning backlight method can be utilized for controlling the LEDs on the backlight module 112. Compared with the full on/full off control method, the conventional scanning backlight method can offer the benefit of lower power consumption. However, in the conventional scanning backlight control technology, flickering effects often occur due to improper operating frequency configuration or uneven brightness of scanning areas. In such a situation, the prior art has to be improved.

### SUMMARY OF THE INVENTION

It is therefore a primary objective of the claimed invention to provide a backlight control method and a backlight system.

An embodiment of the invention discloses a backlight control method for a backlight module corresponding to a display panel, comprising dividing the backlight module into a plurality of backlight areas; calculating a first blanking period, an active pixel period and a second blanking period of an image frame according to resolution information of the image frame and a frame rate of the display panel; and sequentially turning on light sources of the plurality of backlight areas after the first blanking period to provide backlight for the display panel during the active pixel period, wherein the light sources of each backlight area are turned on and lasted for a light-on duration; wherein the first blanking period begins at a time point of the beginning of the image frame and ends at a time point of displaying the first active pixel of the image frame, the active pixel period begins at a time point of displaying the first active pixel of the image frame and ends at a time point of displaying the last active pixel of the image frame, and the second blanking period begins at a time point of displaying the last active pixel of the image frame and ends at a time point of the end of the image frame.

An embodiment of the invention further discloses a backlight system, comprising: a backlight module, corresponding to a display panel; and a backlight driving device, comprising: a processing unit for dividing the backlight module into a plurality of backlight areas and calculating a first blanking period, an active pixel period and a second blanking period of an image frame according to resolution information of the image frame and an frame rate of the display panel; and a backlight control unit for sequentially turning on light sources of the plurality of backlight areas during the active pixel period to provide backlights for the display panel, wherein light sources of each backlight area are turned on and lasted for a light-on duration; wherein the first blanking period begins at a time point of the beginning of the image frame and ends at a time point of displaying the first active pixel of the image frame, the active pixel period begins at a time point of displaying the first active pixel of the image frame and ends at a time point of displaying the last active pixel of the image frame, and the second blanking period begins at a time point of displaying the last active pixel of the image frame and ends at a time point of the end of the image frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an LCD system using LED backlighting according to the prior art.

FIG. 2 is a schematic diagram of a backlight system according to an embodiment of the invention.

FIG. 3 is a schematic diagram of the backlight module shown in FIG. 2 and a corresponding display panel of a display device according to an embodiment of the invention.

FIG. 4 is a schematic diagram of an image frame according to an embodiment of the invention.

FIG. 5 is a schematic diagram of an image frame with a display resolution of 1920×1080P pixels according to an embodiment of the invention.

FIG. 6 is a schematic diagram showing horizontal resolution when the display resolution is 1920×1080P pixels according to an embodiment of the invention.

FIG. 7 to FIG. 9 are schematic diagrams showing various backlight control schemes according to embodiments of the invention.

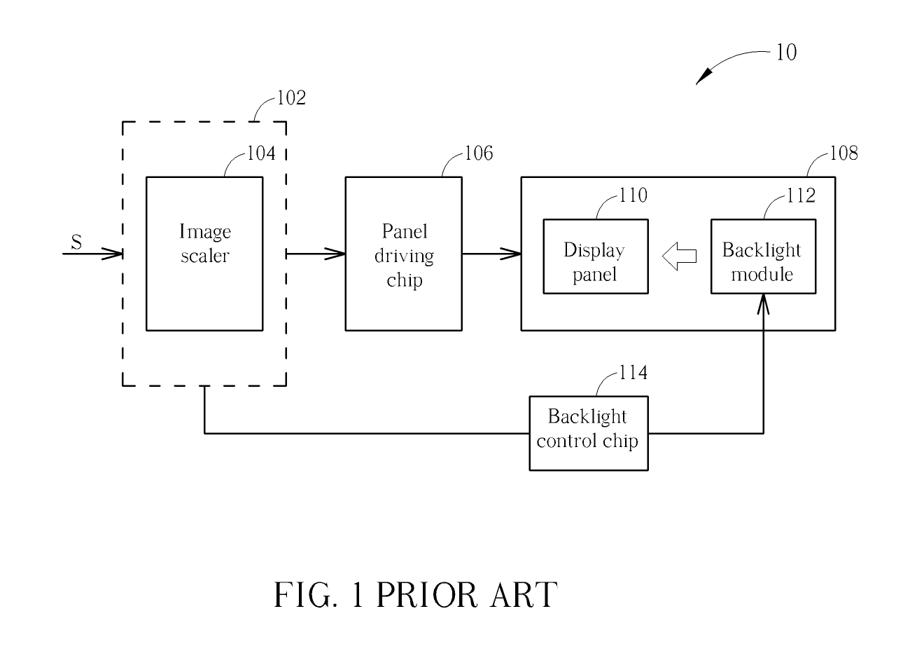

### DETAILED DESCRIPTION

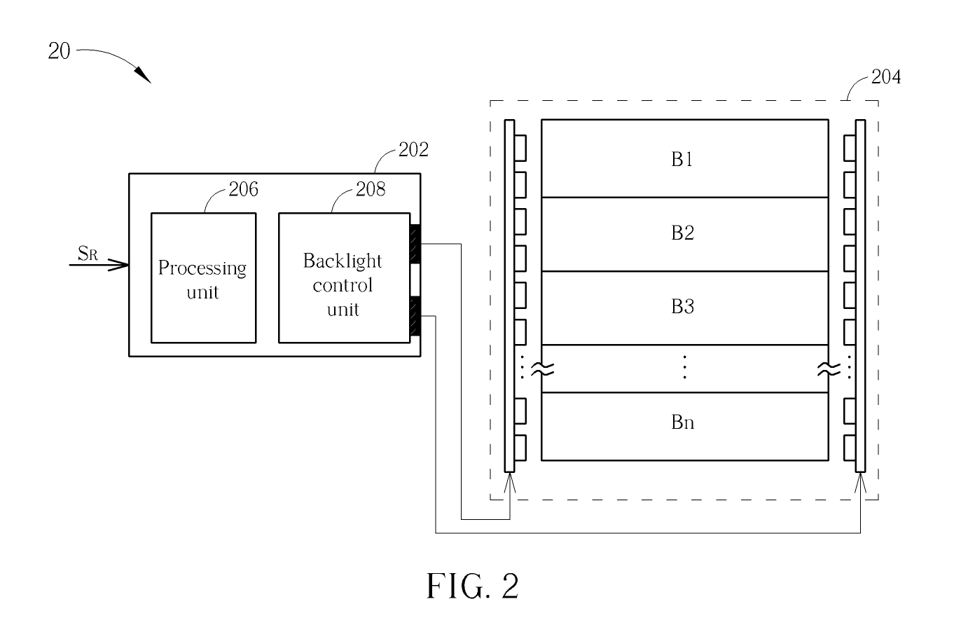

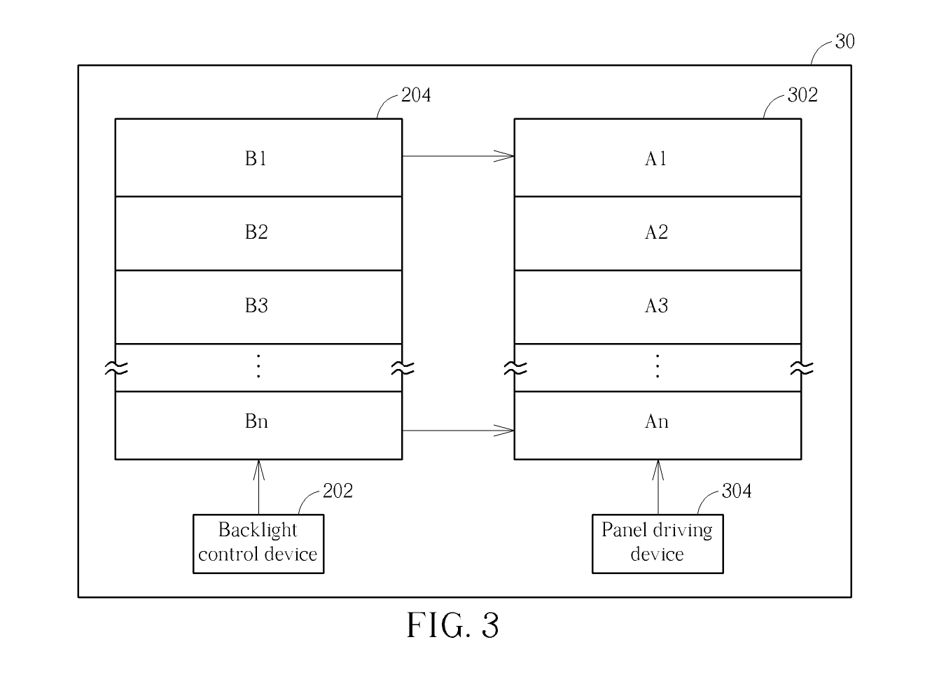

Please refer to FIG. 2, which is a schematic diagram of a backlight system 20 according to an embodiment of the invention. The backlight system 20 is utilized for providing backlight sources for a display panel. The display panel can be a panel of a liquid crystal display (LCD), but this is not a limitation of the invention. The backlight system 20 includes a backlight driving device 202 and a backlight module 204. The backlight driving device 202 includes a processing unit 206 and a backlight control unit 208. The processing unit 206 is utilized for dividing the backlight module 204 into a plurality of backlight areas. For example, as shown in FIG. 2, the backlight module 204 is divided into backlight areas B1 to Bn. Each backlight area includes at least one light source. Preferably, the at least one light source can be realized with light emitting diodes (LEDs). Please refer to FIG. 3, which is a schematic diagram of the backlight module 204 and a corresponding display panel 302 of a display device 30 according to an embodiment of the invention. In the display device 30, an image can be displayed on the display panel 302 via control arrangement of a panel driving device 304. The backlight module 204 is divided into backlight areas B1 to Bn. Light sources in the backlight area B1 are utilized for providing the backlighting required by a display area A1 of the display panel 302. Light sources of the backlight area B2 are utilized for providing the backlighting required by a display area A2 of the display panel 302. Such like this, light sources of the backlight area Bn are utilized for providing the backlighting required by a display area An of the display panel 302.

Please further refer to FIG. 2. The processing unit 206 is able to receive resolution information SR of an image frame. Furthermore, the processing unit 206 calculates a first blanking period, an active pixel period and a second blanking period of the image frame according to the resolution information SR and a frame rate of the display panel. The first blanking period represents a time interval which begins at a time point of the beginning of the image frame and ends at a time point of displaying the first active pixel of the image frame. The active pixel period represents a time interval which begins at a time point of displaying the first active pixel of the image frame and ends at a time point of displaying the last active pixel of the image frame. The second blanking period represents a time interval which begins at a time point of displaying the last active pixel of the image frame and ends at a time point of the end of the image frame. Therefore, after the first blanking period, the light sources of the backlight areas B1 to Bn are turned on sequentially by the backlight control unit 208 so as to provide backlights for the display panel during the active pixel period. In other words, the backlight control unit 208 starts to turn on the light sources of the backlight areas when the first active pixel of the image frame is displayed. Moreover, the backlight control unit 208 sequentially turns on the light sources of the backlight areas B1 to Bn until the last active pixel of the image frame is displayed. Preferably, light sources of each backlight area are turned on and lasted for a light-on duration.

For example, the processing unit 206 calculates the first blanking period, the active pixel period and the second blanking period of the image frame in advance. The backlight control unit 208 can turn on the light sources of the backlight area B1 for one light-on duration when the first active pixel of the image frame is displayed. After that, the backlight control unit 208 turns off the light sources of the backlight area B1 and turns on the light sources of the backlight area B2 for one light-on duration, and so on until the backlight control unit 208 turns on the light sources of the backlight area Bn for one light-on duration. After the light sources of the backlight area Bn are turned on for one light-on duration, the backlight control unit 208 turns off the light sources of the backlight area Bn. As such, the active pixel period ends when the light sources of the backlight area Bn are turned off by the backlight control unit 208 and the second blanking period of the image frame starts.

In addition, the backlight control unit 208 can control the backlight module 204 to turn off the light sources of the backlight areas B1 to Bn in the first blanking period and the first blanking period.

In brief, the invention can turn off the light sources of the backlight module 204 during the first blanking period and the second blanking period so as to reduce power consumption. Moreover, during the active pixel period, the invention can sequentially turn on the light sources of the backlight areas B1 to Bn for a light-on duration, and thus reducing flicker effects effectively

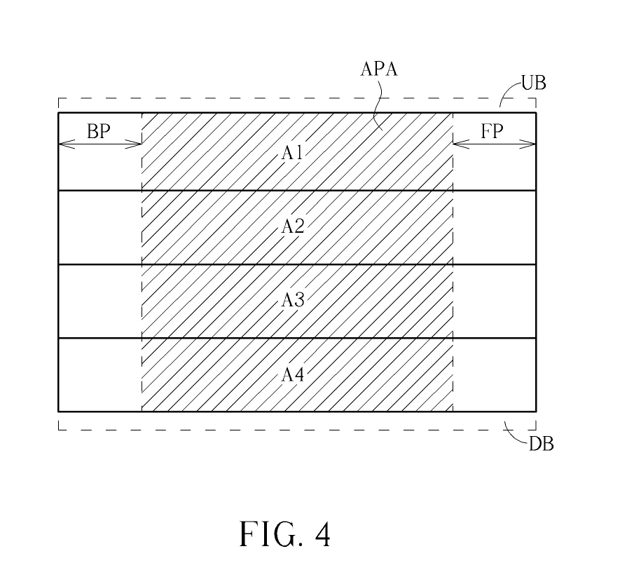

Please refer to FIG. 4, which is a schematic diagram of an image frame according to an embodiment of the invention. The slashed region shown in FIG. 4 represents an active pixel area APA. The active pixel area APA includes active pixels actually displayed by the display panel. An area UB represents an up blanking area of the image frame. An area DB represents a down blanking area of the image frame. Segments BP and FP represent a back porch and a front porch of horizontal blanking, respectively. Areas A1 to A4 represent display areas of the display panel. Moreover, the first blanking period is a time interval between the beginning of the image frame and a time point that the first active pixel in the active pixel area APA is displayed. In detail, the first blanking period includes a time period of the up blanking area UB and a time period of the back porch BP of single horizontal blanking line. Length of the first blanking period equals a sum of the time period of the up blanking area UB of the image frame and the time period of the back porch BP of single horizontal blanking line. Moreover, length of the time period of the up blanking area UB equals a product of the number of horizontal blanking lines in the up blanking area UB and a time period of single horizontal blanking line. Length of the time period of the single horizontal blanking line equals a product of the number of pixels of single horizontal blanking line and a time period of a single pixel. The time period of single pixel equals a frame period of the image frame divided by the number of pixels of the image frame. Therefore, when the related resolution and frame rate information is obtained, the above-mentioned values are calculated by the processing unit 206. As such, the first blanking period is accordingly calculated by the processing unit 206.

Please further refer to FIG. 4. The second blanking period is a time interval between the time point that the last active pixel in the active pixel area APA is displayed and the time point of the end of the image frame. In detail, the second blanking period includes a time period of the down blanking area DB and a time period of the front porch FP of single horizontal blanking line. Length of the second blanking period is a sum of the time period of the down blanking area DB of the image frame and the time period of the front porch FP of single blanking line. Moreover, length of the time period of the down blanking area DB equals a product of the number of horizontal blanking lines in the down blanking area DB and the time period of single horizontal blanking line. As mentioned above, length of the time period of single horizontal blanking line equals a product of the number of pixels of single horizontal blanking line and the time period of single pixel. The time period of single pixel equals the frame period of the image frame divided by the number of pixels of the image frame. Similarly, when the related resolution and frame rate information is obtained, the second blanking period is calculated accordingly.

Please further refer to FIG. 4. The active pixel period is a time interval between a time point that the first active pixel in the active pixel area APA is displayed and a time point that the last active pixel in the active pixel area APA is displayed. In other words, length of the active pixel period equals the frame period subtracted by the first blanking period and the second blanking period. In addition, regarding the above-mentioned light-on duration, length of the light-on duration can be the active pixel period divided by the number of the backlight areas, but this is not limited, the light-on duration can also be adjusted according to various applications and system requirements appropriately.

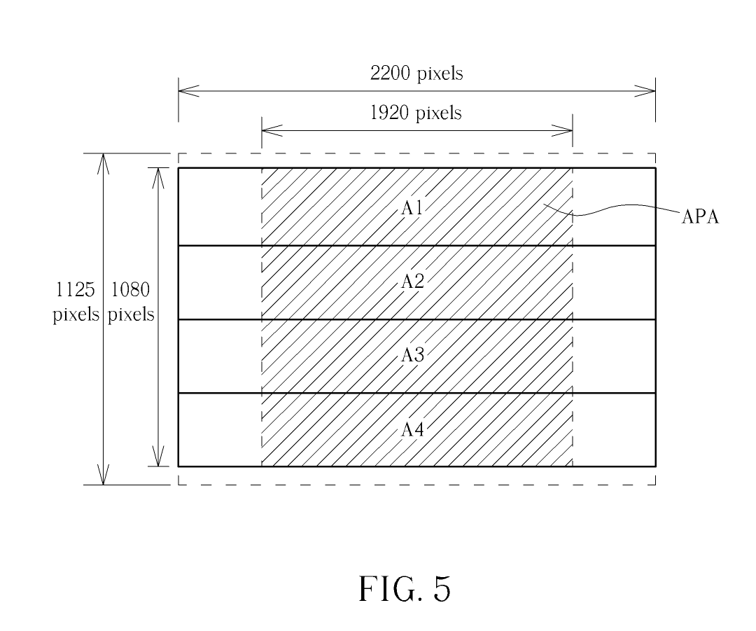

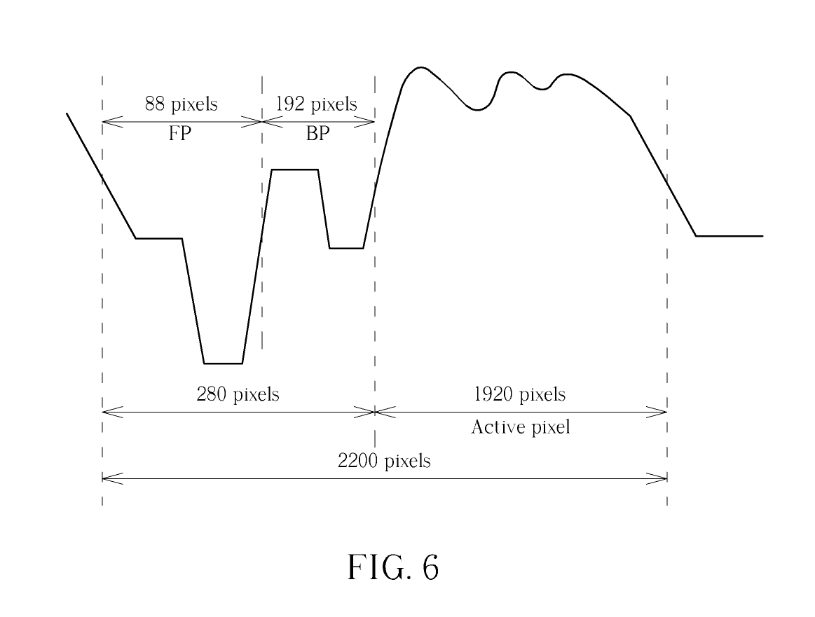

The following further elaborates the operations of the invention. Take a display resolution of 1920×1080P pixels and a 120 Hz frame rate as an example for illustration. Please refer to FIG. 5 and FIG. 6. FIG. 5 is a schematic diagram of an image frame with a display resolution of 1920×1080P pixels according to an embodiment of the invention. FIG. 6 is a schematic diagram showing horizontal resolution when the display resolution is 1920×1080P pixels according to an embodiment of the invention. Suppose an image signal with a display resolution of 1920×1080P and a 60 Hz frame rate is outputted from a multimedia player to an image scaler of a host. The image scaler scales the received image signal according to the video output standard of the display panel and provides related resolution information to the backlight driving device 202. Furthermore, the processing unit 206 of the backlight driving device 202 calculates a first blanking period, an active pixel period and a second blanking period according to the related resolution information.

As shown in FIG. 5, the number of pixels of the image frame is 2200×1125 pixels. The number of pixels per horizontal line is 2200 pixels and the number of pixels per vertical line is 1125 pixels. The number of pixels of vertical blanking line is 45 pixels. As shown in FIG. 6, the number of pixels of the back porch BP per single horizontal line is 192 pixels. The number of pixels of the front porch FP per horizontal line is 88 pixels. The frame period of the image frame is the inverse of the frame rate, i.e. frame period= 1/120=8.3 milli-seconds (ms). The time period of single pixel equals the frame period of the image frame divided by the number of pixels of the image frame, i.e. time period of single pixel=8.3 ms/(2200×1125). The time period of the single horizontal blanking line can be calculated by:

time period of single horizontal blanking line=2200×(8.3 ms/(2200×1125))=7.38 micro-seconds (μs)

When the number of horizontal blanking lines in the up blanking area UB is 23 and the number of horizontal blanking lines in the down blanking area DB is 22. The time period of the up blanking area UB is (7.38 us×23). The time period of the back porch BP of single blanking line is 192×(8.3 ms/(2200×1125)). The first blanking period can be derived as:

first blanking period=7.38 μs×23+192×(8.3 ms/(2200×1125))=0.17614 ms

In other words, the first blanking period is the time interval from the beginning of the image frame to 0.17614 ms. The first active pixel in the active pixel area APA is displayed at 0.17614 ms.

Furthermore, the time period of the down blanking area DB is (7.38 us×22). The time period of the front porch FP of single blanking line is 88×(8.3 ms/(2200×1125)). The second blanking period can be derived as:

second blanking period=7.38 μs×22+88×(8.3 ms/(2200×1125))=0.162294 ms

Therefore, the last active pixel in the active pixel area APA is displayed at 8.1377 ms (8.3 ms−0.162294 ms). The second blanking period is the time interval from 8.1377 ms after the beginning of the image frame to the end of the image frame. The active pixel period is the time interval from 0.17614 ms to 8.1377 ms.

Please further refer to FIG. 5. If the backlight module 204 is divided into backlight areas B1 to B4. The backlight areas B1 to B4 provide backlight for the display areas of the display panel, respectively. The light-on duration is set to be 7.96156 ms/4=1.99039 milli-seconds. The processing unit 206 of the backlight driving device 202 calculates a first blanking period, an active pixel period and a second blanking period. Accordingly, the backlight control unit 208 turns off all light sources of the backlight areas B1 to B4 since the beginning of the image frame. Furthermore, the backlight control unit 208 turns on the light sources of the backlight area B1 at 0.17614 ms. For example, the backlight control unit 208 turns on the light sources of the backlight area B1 at 0.17614 ms and lasts for 1.99039 ms. After that, the backlight control unit 208 turns off the light sources of the backlight area B1 and turns on the light sources of the backlight area B2 for 1.99039 ms, and so on. Such like this, after the backlight control unit 208 turns on the light sources of the backlight area B4 for 1.99039 ms, the second blanking period starts. The backlight control unit 208 turns off the light sources of the backlight area Bn during the second blanking period.

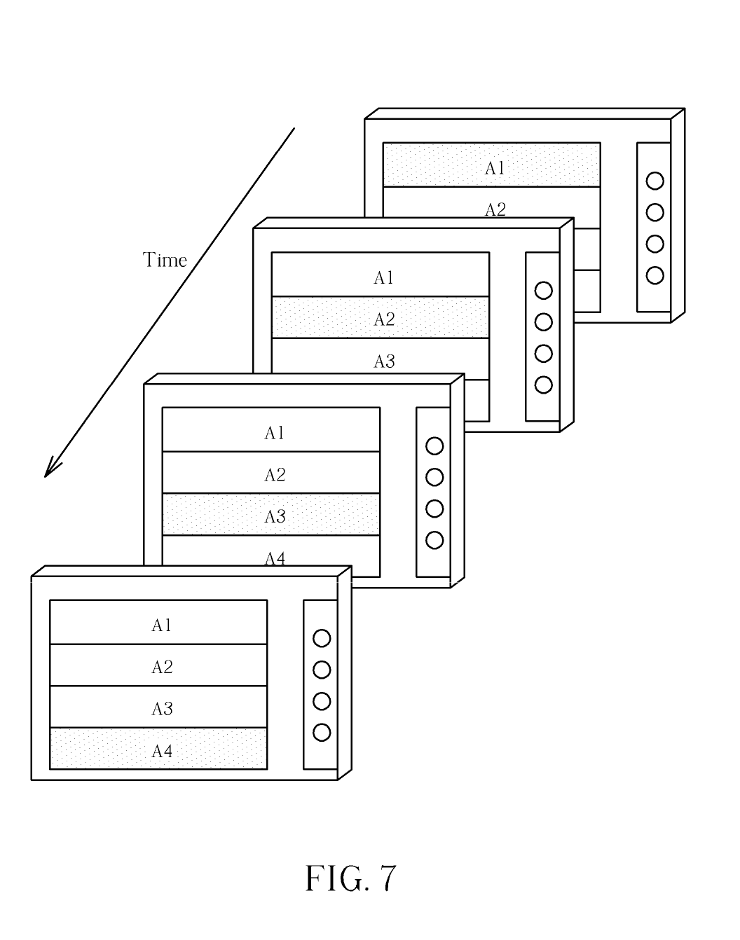

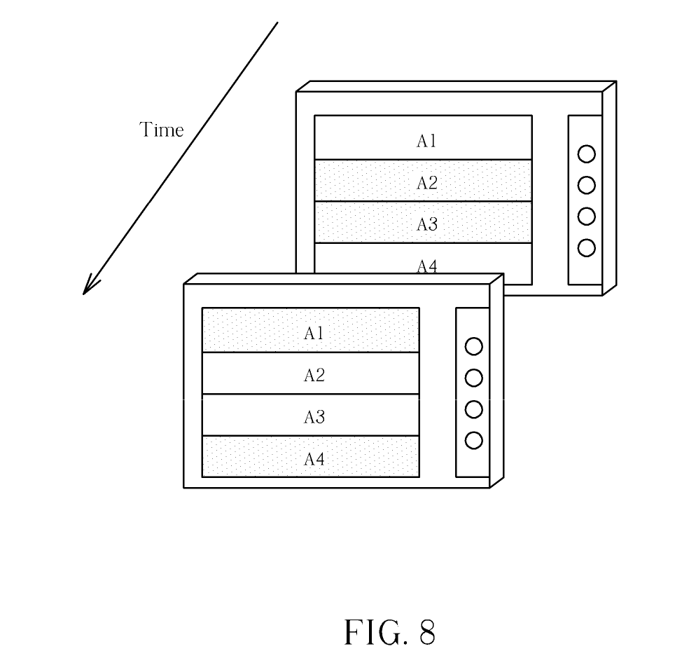

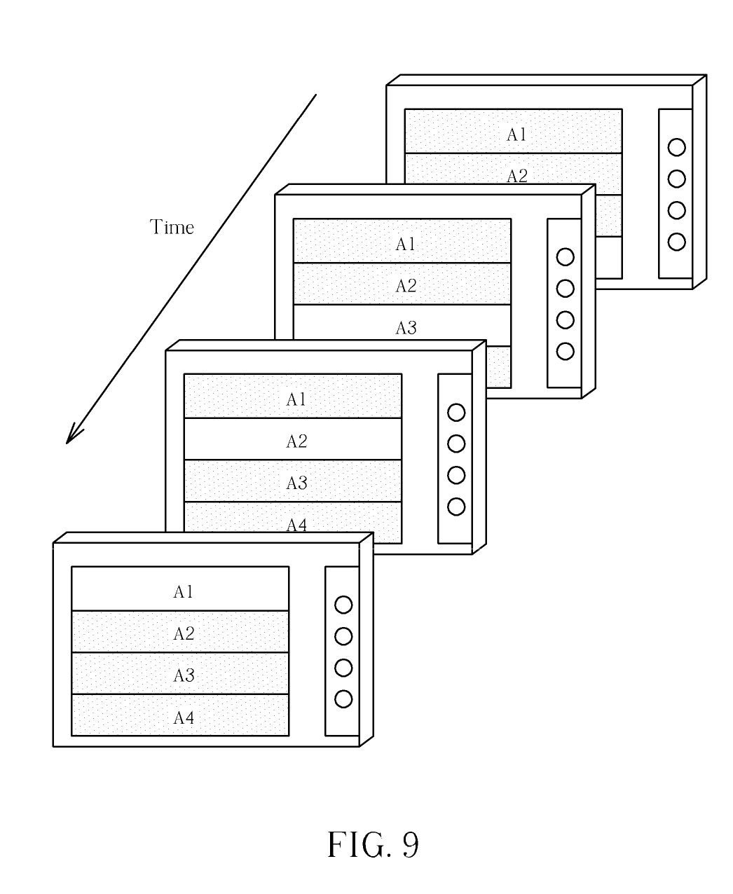

As to the implementation of the backlight control, the following further elaborates operations of the backlight system 20 during active pixel period. Please refer to FIG. 7 to FIG. 9. As shown in FIG. 7, the backlight control unit 208 turns on the light sources of the backlight area B1 (corresponding to the display area A1) for a light-on duration after the first blanking period. After that, the backlight control unit 208 sequentially turns on the light sources of the backlight areas B2 to B4 (respectively corresponding to the display areas A2 to A4). Moreover, light sources of each backlight area are turned on and lasted for one light-on duration. The backlight control method shown in FIG. 7 indicates turning on single backlight area for each alternative operation. The backlight control methods shown in FIG. 8 and FIG. 9 indicate turning on multiple backlight areas for each alternative operation.

Note that embodiments of the backlight system 20 are exemplary embodiments of the invention, and those skilled in the art can make alternations and modifications accordingly. For example, the backlight module 204 can adopt any type of light source arrangement. Any kind of light source can be utilized for realizing the backlight module 204. The processing unit 206 may be disposed anywhere on the backlight driving device. Moreover, the processing unit 206 can be integrated into a host.

In summary, the invention can turn off the light sources of the backlight module 204 during the first blanking period and the second blanking period so as to reduce power consumption. Moreover, during the active pixel period, the invention can sequentially turn on the light sources of the backlight areas B1 to Bn for a light-on duration, and thus reducing flicker effects effectively.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight control method for a backlight module corresponding to a display panel, comprising:
dividing the backlight module into a plurality of backlight areas;
calculating a first blanking period, an active pixel period and a second blanking period of an image frame according to resolution information of the image frame and a frame rate of the display panel; and
sequentially turning on light sources of the plurality of backlight areas during the active pixel period to provide backlights for the display panel, wherein light sources of each backlight area are turned on and lasted for a light-on duration;
wherein the first blanking period begins at a time point of the beginning of the image frame and ends at a time point of displaying the first active pixel of the image frame, the active pixel period begins at a time point of displaying the first active pixel of the image frame and ends at a time point of displaying the last active pixel of the image frame, and the second blanking period begins at a time point of displaying the last active pixel of the image frame and ends at a time point of the end of the image frame.

2. The backlight control method of claim 1, wherein the light sources of the plurality of backlight areas are turned off during the first blanking period.

3. The backlight control method of claim 1, wherein the light sources of the plurality of backlight areas are turned off during the second blanking period until to the end of the image frame.

4. The backlight control method of claim 1, wherein length of the first blanking period equals a sum of a time period of an up blanking area of the image frame and a time period of a back porch of a single horizontal blanking line.

5. The backlight control method of claim 4, wherein length of the second blanking period equals a sum of a time period of a down blanking area of the image frame and a time period of a front porch of a single horizontal blanking line.

6. The backlight control method of claim 5, wherein length of the active pixel period equals a difference between a frame period of the image frame and a blanking period, wherein the blanking period equals a sum of the first blanking period the second blanking period, and the frame period of the image frame equals the inverse of the frame rate.

7. The backlight control method of claim 6, wherein length of the light-on duration equals the active pixel period divided by the number of the plurality of backlight areas.

8. The backlight control method of claim 4, wherein length of the up blanking area equals a product of the number of horizontal blanking lines in the up blanking area and the time period of a single horizontal blanking line, length of the time period of the single horizontal blanking line equals a product of the number of pixels on the single horizontal blanking line and a time period of a single pixel, and length of the time period of the single pixel equals a frame period of the image frame divided by the number of pixels of the image frame.

9. The backlight control method of claim 5, wherein length of the down blanking area equals a product of the number of horizontal blanking lines in the down blanking area and the time period of a single horizontal blanking line, length of the time period of the single horizontal blanking line equals a product of the number of pixels on the single horizontal blanking line and a time period of a single pixel, and length of the time period of the single pixel equals a frame period of the image frame divided by the number of pixels of the image frame.

10. The backlight control method of claim 1, wherein the step of sequentially turning on light sources of the plurality of backlight areas during the active pixel period comprises:
after the first blanking period, turning on light sources of at least one first backlight area of the plurality of backlight areas and lasting for the light-on duration; and
turning on light sources of at least one second backlight area of the plurality of backlight areas and lasting for the light-on duration after turning on the light sources of the at least one first backlight area and lasting for the light-on duration.

11. A backlight system, comprising:
a backlight module, corresponding to a display panel; and
a backlight driving device, comprising:
a processing unit for dividing the backlight module into a plurality of backlight areas and calculating a first blanking period, an active pixel period and a second blanking period of an image frame according to resolution information of the image frame and an frame rate of the display panel; and
a backlight control unit for sequentially turning on light sources of the plurality of backlight areas during the active pixel period to provide backlights for the display panel, wherein light sources of each backlight area are turned on and lasted for a light-on duration;
wherein the first blanking period begins at a time point of the beginning of the image frame and ends at a time point of displaying the first active pixel of the image frame, the active pixel period begins at a time point of displaying the first active pixel of the image frame and ends at a time point of displaying the last active pixel of the image frame, and the second blanking period begins at a time point of displaying the last active pixel of the image frame and ends at a time point of the end of the image frame.

12. The backlight system of claim 11, wherein backlight control unit turns off the light sources of the plurality of backlight areas during the first blanking period.

13. The backlight system of claim 11, wherein backlight control unit turns off the light sources of the plurality of backlight areas during the second blanking period until to the end of the image frame.

14. The backlight system of claim 11, wherein length of the first blanking period equals a sum of a time period of an up blanking area of the image frame and a time period of a back porch of a single horizontal blanking line.

15. The backlight system of claim 14, wherein length of the second blanking period equals a sum of a time period of a down blanking area of the image frame and a time period of a front porch of a single horizontal blanking line.

16. The backlight system of claim 15, wherein length of the active pixel period equals a difference between a frame period of the image frame and a blanking period, wherein the blanking period equals a sum of the first blanking period the second blanking period, and the frame period of the image frame equals the inverse of the frame rate.

17. The backlight system of claim 16, wherein length of the light-on duration equals the active pixel period divided by the number of the plurality of backlight areas.

18. The backlight system of claim 14, wherein length of the up blanking area equals a product of the number of horizontal blanking lines in the up blanking area and the time period of a single horizontal blanking line, length of the time period of the single horizontal blanking line equals a product of the number of pixels on the single horizontal blanking line and a time period of a single pixel, and length of the time period of the single pixel equals a frame period of the image frame divided by the number of pixels of the image frame.

19. The backlight system of claim 15, wherein length of the down blanking area equals a product of the number of horizontal blanking lines in the down blanking area and the time period of a single horizontal blanking line, length of the time period of the single horizontal blanking line equals a product of the number of pixels on the single horizontal blanking line and a time period of a single pixel, and length of the time period of the single pixel equals a frame period of the image frame divided by the number of pixels of the image frame.

20. The backlight system of claim 11, wherein the backlight control unit turns on light sources of at least one first backlight area of the plurality of backlight areas and lasts for the light-on duration after the first blanking period, and the backlight control unit turns on light sources of at least one second backlight area of the plurality of backlight areas and lasts for the light-on duration.

21. The backlight system of claim 11, wherein the processing unit is integrated into a host.
